(19) United States
(12) Patent Application Publication
(10) Pub. No.: US 2018/0023525 A1
(43) Pub. Date: Jan. 25, 2018

(54) SEA WATER INFLOW PREVENTION DEVICE FOR A MARINE ENGINE

(71) Applicant: HLB CO., LTD. COMPOSITE MATERIAL DIVISION, Ulsan (KR)

(72) Inventors: Jung Min PARK, Incheon (KR); Pal Gon EUN, Ulsan (KR)

(73) Assignee: HLB CO., LTD. COMPOSITE MATERIAL DIVISION, Ulsan (KR)

(21) Appl. No.: 15/655,896

(22) Filed: Jul. 21, 2017

(30) Foreign Application Priority Data
Jul. 21, 2016 (KR) 10-2016-0092595

(51) Int. Cl. F02M 35/16; F02D 9/04; F02D 41/04; F02D 9/02

(52) U.S. Cl. CPC F02M 35/165; F02D 9/02; F02D 9/04; F02D 41/042; F02D 2009/0269; F02D 2009/0228; B63H 21/32

(57) ABSTRACT

A sea water inflow prevention device for a marine engine, includes; an intake valve that is installed at an air inlet of the marine engine to open or close the air inlet; and a valve drive portion that one side thereof is connected with the air inlet that is disposed between the intake valve and the marine engine, the other side thereof is connected with the air intake valve, makes the air intake valve open the air inlet, when a negative pressure inside the air inlet becomes larger than a tension of a spring member provided inside, and makes the air intake valve close the air inlet, when the negative pressure inside the air inlet is less than a tension of the spring member.

### CROSS-REFERENCE TO RELATED APPLICATION

This application claims priority to and the benefit of Korean Patent Application No. 10-2016-0092595 filed in the Korean Intellectual Property Office on Jul. 21, 2016, the entire contents of which are incorporated herein by reference.

### BACKGROUND OF THE INVENTION

### (a) Field of the Invention

The present invention relates to a sea water inflow prevention device for a marine engine that prevents sea water from inflowing through an air inlet or an exhaust gas outlet of the engine during operation of the ship.

### (b) Description of the Related Art

Generally, a marine engine has an air inlet (In-manifold) in which air flows into a combust chamber and an exhaust gas outlet (Ex-manifold) in which combusted air is discharged to the outside.

In the case of a large ship, the engine is accommodated in a separate engine room, and in the case of the engine, the engine is installed to be exposed to the outside of the ship without an engine room.

At this time, when the sea water flows into the engine room of the ship and the sea water inflows through the intake line, or when the ship is overturned, sea water inflows through the aft inlet and exhaust gas outlet to cause engine failure.

Therefore, in the past, an exhaust gas outlet or an air inlet was disposed over a certain height or the shape of an exhaust gas outlet or an air inlet was changed to prevent inflow of sea water into the engine so that sea water can not flow through an exhaust gas outlet or an air inlet, however, stable exhaust and intake are difficult, and installation thereof is difficult due to interference with other facilities. Also, there is a problem that it is difficult to prevent the sea water from flowing into the engine, when the sea water flows into the ship due to overturning of the ship.

The exhaust pipe of the engine for ship related this technology is registered in Korean Registered Utility Model No. 20-0149855 (Mar. 30, 1999).

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a sea water inflow prevention device for a marine engine having advantages of reliably preventing from flowing into a marine engine through an air inlet or an exhaust gas outlet.

The present invention provides a sea water inflow prevention device for a marine engine that includes an intake valve that is installed at an air inlet of the marine engine to open or close the air inlet, and a valve drive portion that one side thereof is connected with the air inlet that is disposed between the intake valve and the marine engine, the other side thereof is connected with the air intake valve, makes the air intake valve open the air inlet, when a negative pressure inside the air inlet becomes larger than a tension of a spring member provided inside, and makes the air intake valve close the air inlet, when the negative pressure inside the air inlet is less than a tension of the spring member.

Also, the present invention provides a sea water inflow prevention device for a marine engine that includes an air intake valve that is disposed in an air inlet of the marine engine to open or close the air inlet, an exhaust valve that is disposed in an exhaust gas outlet of the engine to open or close the exhaust gas outlet, a posture sensor that detects a position of the engine, and a controller that is connected to the air intake valve, the exhaust valve, the posture sensor, and the engine, opens the air inlet and the exhaust gas outlet through the air intake valve and the exhaust valve during the operation of the engine, and if a position of the engine that is detected by the posture sensor is tilted more than a predetermined angle, after stopping the engine, closes the air inlet and the exhaust gas outlet through the air intake valve and the exhaust valve.

A sea water inflow prevention device for a marine engine according to an exemplary embodiment prevents inflow of sea water to the marine engine 10 via the air inlet 11 depending on whether the marine engine 10 is operating or not, in the condition that the negative pressure occurs as the marine engine 10 is operated, the valve drive portion 110 causes the air intake valve 100 to remain open and in the condition that the generation of the negative pressure is removed while the marine engine 10 is stopped, the valve drive portion 110 keeps the air intake valve 100 be closed and sealed.

### BRIEF DESCRIPTION OF THE DRAWINGS

FIG. 1 is a schematic cross-sectional view of a sea water inflow prevention device for a marine engine according to an exemplary embodiment of the present invention.

FIG. 2 is a cross-sectional view of a sea water inflow prevention device for a marine engine according to another exemplary embodiment of the present invention.

### DETAILED DESCRIPTION OF THE EMBODIMENTS

Hereinafter, preferred embodiments of the present invention will be described in detail with reference to the accompanying drawings.

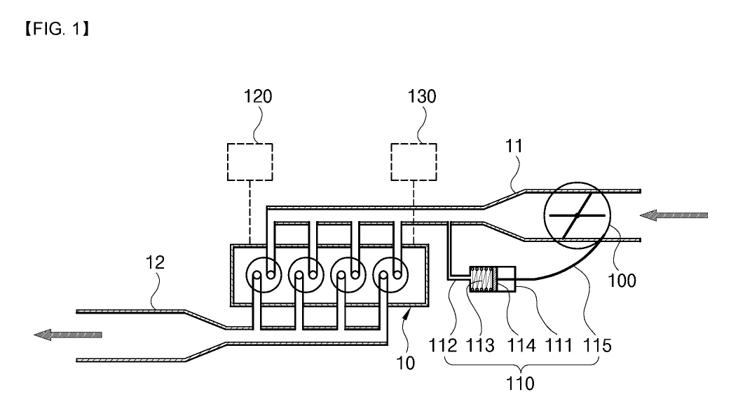

FIG. 1 is a schematic cross-sectional view of a sea water inflow prevention device for a marine engine according to an exemplary embodiment of the present invention. Referring to FIG. 1, a sea water inflow prevention device for a marine engine of an exemplary embodiment includes an air intake valve 100, and a valve drive portion 110.

The air intake valve 100 is disposed in an air inlet 11 to open or close the air inlet 11. The air intake valve 100 is connected with the valve drive portion 110, which will be described later, to open or close the air inlet 11 according to the operation of the valve drive portion 110, if the air inlet 11 is opened, air is supplied to the marine engine 10, and if the air inlet 11 is closed, the air supply to the marine engine 10 is shut off and the sea water is prevented from flowing through the air inlet 11.

The valve drive portion 110 operates the air intake valve 100 according to the magnitude of the negative pressure in the air inlet 11 to open or close the air inlet 11. That is, the negative pressure inside the air inlet 11 becomes larger than a predetermined pressure value from the operation of the marine engine 10, the valve drive portion 110 operates the air intake valve 100 to open the air inlet 11 such that the air is supplied to the marine engine 10 through the air inlet 11. And, if the internal pressure of the air inlet 11 becomes smaller than a set pressure from a halt of the marine engine 10, the valve drive portion 110 operates the air intake valve 100 to close the air inlet 11 such that air is not supplied to the marine engine 10 and the sea water is not supplied through the air inlet 11. One side of the valve drive portion 110 is connected with one side of the air inlet 11 positioned between the air intake valve 100 and the marine engine 10 to be able to receive pressure of the air inlet 11, and the other side of the valve drive portion 110 is connected with the air intake valve 100 to operate the air intake valve 100 according to the inside pressure of the air inlet 11. Here, the valve drive portion 110 includes a drive body 111, a moving plate 114, and a drive connection member 115.

The drive body 111 is a tubular member provided with a space inside thereof. The drive body 111 is connected with the air inlet 11 to receive the pressure inside the air inlet 11 from the air inlet 11. Here, a connection line 112 is formed at one side of the drive body 111 to connect a space portion inside the drive body 110 with the air inlet 11. And, a spring member 113 is disposed inside the drive body 111 to elastically support the moving plate 114. At this time, one end of the spring member 113 is disposed to contact the inner side of one side of the drive body 111, and other end of the spring member 113 is disposed to contact the moving plate 114. Here, the spring member 113 pushes the moving plate 114 to make the air intake valve 100 closes the air inlet 11, when the marine engine is halted. Accordingly, when the negative pressure of the air inlet 11 is greater than the tension of the spring member 113, the air intake valve 100 opens the air inlet 11 while the moving plate 114 compresses the spring member 113.

The moving plate 114 is a plate portion slidably inserted into a space portion of the drive body 111. The moving plate 114 is formed to have a shape corresponding to the inner surface of the drive body 111 so as to contact the inner side of the drive body 111. And, one side surface of the moving plate 114 is connected with the other end of the spring member 113.

The drive connection member 115 is a connection element that transfers a moving force of the moving plate 114 to the air intake valve 100 to have a bar type. That is, the drive connection member 115 moves correspondingly to the movement of the moving plate 114, thereby opening and closing the air intake valve 100 and making the air inlet 11 be opened or closed. One end of a length direction of the drive connection member 115 is connected to the other side of the moving plate 114 and the other end of a length direction of the drive connection member 115 is connected to the air intake valve 100.

In a condition that the valve drive portion 110 drives the air intake valve 100 depending on a condition that the negative pressure is generated or not according to the operation of the marine engine 10, a sea water inflow prevention device for a marine engine according to an exemplary embodiment includes a sea water sensor 120 that stops the marine engine 10 when a predetermined amount of sea water flows into the ship 120 and a posture sensor 130 that stops the marine engine 10 when a position of the marine engine 10 is tilted more than a predetermined angle. The sea water sensor 120 is disposed on the ship to be connected to the marine engine 10. And, the posture sensor 130 is disposed to be connected to one side of the marine engine 10 so as to accurately detect a tilt degree of the marine engine 10. Here, in a case that a tilt degree of the marine engine 10 becomes larger than a predetermined angle, the posture sensor 130 assumes that the ship is overturned and stops the marine engine 10.

Here, it is described that a sea water inflow prevention device for a marine engine of an exemplary embodiment disposes an air intake valve 100 in only the air inlet 11 and controls the air intake valve 100 through the valve drive portion 110, but it is not limited thereto, an exhaust valve (not shown) 12 can be disposed in an exhaust gas outlet 12 to open or close the exhaust gas outlet 12, the exhaust valve is also connected to the valve drive portion 110, as described above, when the air inlet 11 is closed by the air intake valve 100, the exhaust gas outlet 12 is also closed by the exhaust valve to prevent sea water from flowing through the exhaust gas outlet 12.

Referring to FIG. 1, an operation of a sea water inflow prevention device for a marine engine of an exemplary embodiment configured in the above method will be described as follows.

First, when the marine engine 10 is operated, the negative pressure inside the air inlet 11 is generated, and when the negative pressure inside the air inlet 11 becomes larger than the tension of the spring member 113 of the valve drive portion 110, the moving plate 114 is moved to compress the spring member 113. Then, the drive connection member 115 pulls the air intake valve 100 and keeps the air inlet 11 open so that air is supplied to the marine engine 10 via the air inlet 11.

If the marine engine 10 is halted, that is, if the operator stops the engine 10 directly via the ship's starting switch (not shown), if the sea water sensor 120 detects a certain amount of sea water in the ship, or if the inclination angle of the marine engine 10 detected by the posture sensor 130 is higher than a predetermined angle, the air inlet 11 is no longer operated after the internal negative pressure is lowered. Then, as the tension of the spring member 113 becomes larger than the pressure in the air inlet 11, the moving plate 114 of the valve drive portion 110 elastically supports the moving plate 114 to return to the original state. The drive connection member 115 then pushes the air intake valve 100 to keep the air inlet 11 be closed such that the air or sea water to the marine engine 10 cannot be supplied through the air inlet 11.

Like this, a sea water inflow prevention device for a marine engine according to an exemplary embodiment prevents inflow of sea water to the marine engine 10 via the air inlet 11 depending on whether the marine engine 10 is operating or not, in the condition that the negative pressure occurs as the marine engine 10 is operated, the valve drive portion 110 causes the air intake valve 100 to remain open and in the condition that the generation of the negative pressure is removed while the marine engine 10 is stopped, the valve drive portion 110 keeps the air intake valve 100 be closed and sealed.

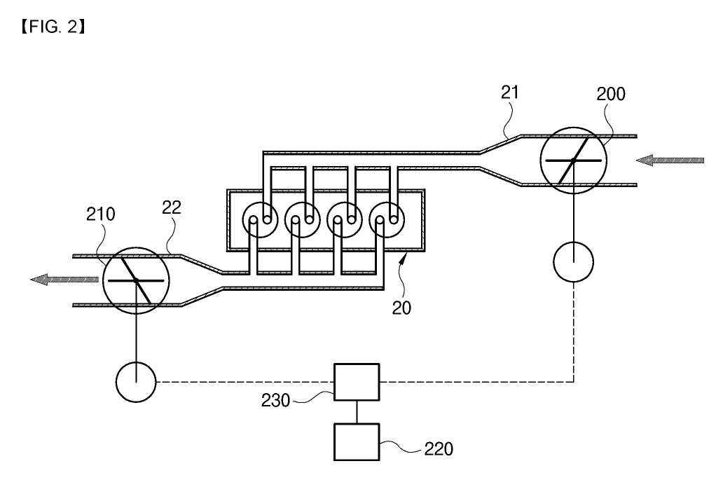

FIG. 2 is a cross-sectional view of a sea water inflow prevention device for a marine engine according to another exemplary embodiment of the present invention. Referring to FIG. 2, a sea water inflow prevention device for a marine engine of another exemplary embodiment includes an air intake valve 200, an exhaust valve 210, a posture sensor 220, and a controller 230.

The air intake valve 200 is disposed at the air inlet 21 to open and close the air inlet 21 that supplies the marine engine 20 with air. The air intake valve 200 is connected with the controller 230 that will be described later and opens or closes the air inlet 21 according to the operating signal transmitted from the controller 230, when the air inlet 21 is opened, air can be supplied to the marine engine 20, and when the air inlet 21 is closed, the air supply to the marine engine 20 is shut off and the air inlet 11 prevents the inflow of sea water.

The exhaust valve 210 is disposed to open or close the exhaust gas outlet 22 that exhausts combustion gas generated from the marine engine 20. The exhaust valve 210 is connected with the controller 230 that will be described later, opens or closes the exhaust gas outlet 22 according to an operation signal transmitted from the controller 230, when the air inlet 21 is opened, air is supplied to the marine engine 20, and when the air inlet 21 is closed, the air supply to the marine engine 20 is cut off and the sea water is prevented from flowing through the air inlet 11.

Here, the air intake valve 200 and the exhaust valve 210 are preferably used by selecting a solenoid valve for opening and closing the air inlet 210 and the exhaust gas outlet 22 by receiving a signal of the controller 230, but it is not limited thereto.

The posture sensor 220 senses the position of the marine engine 20. The posture sensor 220 is installed in the marine engine 20 and is connected to a controller 230 to be described later, and the slope angle of the marine engine 20 is sensed by the posture sensor 220 to be transmitted to the controller 230.

The controller 230 controls the operation of the air intake valve 200 and the exhaust valve 210 according to ON/OFF condition of the marine engine 20 and the tilt angle of the marine engine 20 sensed by the posture sensor 220. Here, the controller 230 is disposed to be connected to the air intake valve 200, the exhaust valve 210, the posture sensor 220, and the marine engine 20.

When the marine engine 20 is started, that is, if the starting switch of the marine engine 20 is turned on, the controller 230 opens the air inlet 21 using the air intake valve 200 and opens the exhaust gas outlet 22 using the exhaust valve 210. And, if a tilting position of the marine engine 20 detected by the posture sensor 220 is higher than a predetermined angle, the controller 230 closes the air inlet 21 through the air intake valve 200 and closes the exhaust gas outlet 22 through the exhaust valve 210.

Here, when controlling the operation of the air intake valve 200 and the exhaust valve 210 to close the air inlet 21 and the exhaust gas outlet 22 by the signal of the posture sensor 220, the controller 230 stops the operation of the marine engine 20.

Another example of such a constructed sea water inflow prevention device is shown in FIG. 2, description is as follows.

First, while the marine engine 10 is being operated, that is, when the starting switch of the marine engine 10 is turned on, the controller 230 opens the air inlet 21 by opening the air intake valve 200 and opens the exhaust gas outlet 22 by opening the exhaust valve 210. Then, air is supplied to the marine engine 10 through the air inlet 21, and after being combusted in the marine engine 20, exhaust gas is discharged to the outside of the engine 20 through the exhaust gas outlet 22.

If the ship is tilted more than a predetermined angle during operation, that is, when the ship is rolled over, the posture sensor 220 transmits the sensed signal to the controller 230 so that the air intake valve 200 and the exhaust valve 210 are controlled to be operated. That is, when the air inlet 21 is closed by the air intake valve 200 and the exhaust gas outlet 22 is closed by the exhaust valve 210, the air supply and the sea water inflow through the air inlet 21 are blocked, and the sea water inflow through the exhaust gas outlet 22 is also blocked.

At his point, the controller 230 controls the marine engine 20 to stop operating.

As such, in a sea water inflow prevention device for a marine engine according to another exemplary embodiment, depending on the tilt degree of the ship detected from the posture sensor 220, the controller 230 controls the air intake valve 200 and the exhaust valve 210 to open or close the air inlet 21 and the exhaust gas outlet 22, if the ship is tilted more than a predetermined angle, the signal transferred from the posture sensor 220 to the controller 230 controls the air intake valve 200 and the exhaust valve 210 to close the air inlet 21 and the exhaust gas outlet 22, when the ship is overturned, the inflow of sea water through the air nlet 21 and the exhaust gas outlet 22 is blocked.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of symbols>

| | |
|---|---|
| 10, 20: | marine engine |
| 11, 21: | air inlet |
| 12, 22: | exhaust gas outlet |
| 100, 200: | air intake valve |
| 110: | valve drive portion |
| 111: | drive body |
| 112: | connection line |
| 113: | spring member |
| 114: | moving plate |
| 115: | drive connection member |
| 120: | sea water sensor |
| 130, 220: | posture sensor |
| 210: | exhaust valve |
| 230: | controller |

What is claimed is:

1. A sea water inflow prevention device for a marine engine, comprising;
an intake valve that is installed at an air inlet of the marine engine to open or close the air inlet; and
a valve drive portion that one side thereof is connected with the air inlet that is disposed between the intake valve and the marine engine, the other side thereof is connected with the air intake valve, makes the air intake valve open the air inlet, when a negative pressure inside the air inlet becomes larger than a tension of a spring member provided inside, and makes the air intake valve close the air inlet, when the negative pressure inside the air inlet is less than a tension of the spring member.

2. The sea water inflow prevention device for a marine engine of claim 1, wherein the valve drive portion includes,
a drive body that has a pipe shape having a space portion, a connection line is formed to connect the air inlet with the space portion, and the spring member is inserted inside,
a moving plate that is slidably inserted into the drive body and is elastically supported by the spring member, and
a driving connection member that one end is connected to the moving plate and the other end is connected to the air intake valve, and drives the air intake valve in response to the movement of the moving plate to open and close the air inlet.

3. The sea water inflow prevention device for a marine engine of claim 1, further comprising a sea water sensor that is connected with the engine and stops the engine so as to prevent the negative pressure inside the air inlet, when a predetermined amount of sea water flows into the ship.

4. The sea water inflow prevention device for a marine engine of claim 1, further comprising a posture sensor that is disposed on the engine and stops the engine to prevent negative pressure generation inside the air inlet, when the engine is tilted more than a predetermined angle.

5. A sea water inflow prevention device for a marine engine, comprising;
an air intake valve that is disposed in an air inlet of the marine engine to open or close the air inlet;
an exhaust valve that is disposed in an exhaust gas outlet of the engine to open or close the exhaust gas outlet;
a posture sensor that detects a position of the engine; and
a controller that is connected to the air intake valve, the exhaust valve, the posture sensor, and the engine, opens the air inlet and the exhaust gas outlet through the air intake valve and the exhaust valve during the operation of the engine, and if a position of the engine that is detected by the posture sensor is tilted more than a predetermined angle, after stopping the engine, closes the air inlet and the exhaust gas outlet through the air intake valve and the exhaust valve.

6. The sea water inflow prevention device for a marine engine of claim 5, wherein the air intake valve and the exhaust valve are a solenoid valve.
